(19) United States
(12) Patent Application Publication
(10) Pub. No.: US 2025/0274658 A1
(43) Pub. Date: Aug. 28, 2025

(54) IMAGE DETECTION APPARATUS AND AUTOFOCUSING METHOD

(71) Applicant: MITUTOYO CORPORATION, Kanagawa (JP)

(72) Inventor: Yuki KURAHASHI, Tokyo (JP)

(73) Assignee: MITUTOYO CORPORATION, Kanagawa (JP)

(21) Appl. No.: 19/058,114

(22) Filed: Feb. 20, 2025

(30) Foreign Application Priority Data
Feb. 22, 2024 (JP) 2024-025556

(51) Int. Cl. H04N 23/67; G01S 17/08

(52) U.S. Cl. CPC H04N 23/671; G01S 17/08

(57) ABSTRACT

An image detection apparatus includes an image detector that detects an image of a detection target through a liquid resonant variable-focus lens system, a distance detector that detects a detection distance to the detection target, and a detection controller that controls the image detector and the distance detector. The detection controller controls a focal position of the image detector on a basis of the detection distance detected by the distance detector.

### CROSS REFERENCE TO RELATED APPLICATIONS

The entire disclosure of Japanese Patent Application No. 2024-025556 filed Feb. 22, 2024 is expressly incorporated by reference herein.

### TECHNICAL FIELD

The present invention relates to an image detection apparatus and an autofocusing method.

### BACKGROUND ART

An image detection apparatus has a mechanical focusing mechanism on an optical path in order to perform a focusing for projecting an image of a detection target onto an image pickup device. For image detection, in order to bring the focusing mechanism into an in-focus state, a focusing operation is performed through contrast determination of an image detected at each of focal positions while scanning the focal positions, i.e., changing the focal positions (see Literature 1: JP 2020-38319 A).

In recent years, an image detection apparatus employs a liquid resonant variable-focus lens system. In the liquid resonant variable-focus lens system, pulsed illumination is performed in synchronization with a predetermined phase angle in a high-frequency driving signal that resonates liquid, thereby obtaining an image at a focal position corresponding to the phase angle (see Literature 2: JP 2017-223651 A).

In this image detection apparatus employing the liquid resonant variable-focus lens system, the above-described mechanical focusing mechanism can be omitted, making it possible to speed up operations, prolong a lifetime, and eliminate wear dust and the like.

In the above-described image detection apparatus employing the liquid resonant variable-focus lens system, a focal position can be varied in about microseconds. However, if the above-described contrast determination of an image is used as a focusing operation, the image detection at a lot of positions and focus determination processing are required and therefore the focusing operation requires several hundred milliseconds taking an image frame rate into consideration. For this reason, even in the image detection apparatus using the liquid resonant variable-focus lens system where a mechanical focusing mechanism is omitted, an operation speed related to the focusing operation is restricted, and consequently an overall operation speed of the image detection apparatus cannot be increased.

Further, since the image detection is repeated with a gradual change of the focal positions in order to perform the above-described contrast determination, synchronization between the lens system and an image detector is essential, which easily complicates the system, raising necessity to review the system as the image detection apparatus depending on a specification of the image detector.

### SUMMARY OF THE INVENTION

An object of the invention is to provide an image detection apparatus and an autofocusing method which enable a higher operation speed.

According to an aspect of the invention, an image detection apparatus includes: an image detector configured to detect an image of a detection target through a liquid resonant variable-focus lens system; a distance detector configured to detect a detection distance to the detection target; a detection controller configured to control the image detector and the distance detector, in which the detection controller is configured to control a focal position of the image detector on a basis of the detection distance detected by the distance detector.

In the above aspect of the invention, by using the detection distance detected by the distance detector for controlling a focal position in the image detector, contrast detection processing, which is a cause for increasing a processing time in a typical focusing, can be omitted to speed up the focusing operation. Further, absence of contrast detection allows for higher-speed autofocusing than a frame rate of the detection image. Due to this higher-speed focusing operation, the effect of the higher-speed image-detecting operation by the liquid resonant variable-focus lens system can be fully utilized, thus increasing the overall operation speed as the image detection apparatus.

Further, in the above aspect of the invention, the distance detector is separated from the image detector in system, which enables continuous detection of focal positions independently of the image-detecting operation and eliminates the necessity of synchronization between the distance detector and the image detector, so that a system of the image detection apparatus can be prevented from being complicated.

In the above aspect of the invention, a typical optical distance detection device such as a laser interferometer is usable as the distance detector. The distance detector preferably detects a detection distance in a direction along an optical axis of the image detector (image detection optical axis) directed toward a detection target. Here, an optical axis of the distance detector (distance detection optical axis) directed toward the detection target is not limited to being in parallel to the detection optical axis of the image detector but may be inclined. When the distance detection optical axis is inclined relative to the image detection optical axis, a distance detected by the distance detector can be converted into a distance in a direction along the image detection optical axis by a geometrical operation. On the other hand, when the detection distance detected by the distance detector is used for focusing in the image detector, a phase angle of a drive signal of the variable-focus lens system can be calculated on a basis of the detection distance and a timing of the image detection can be changed by pulsed illumination or other means, thereby focusing.

In the above aspect of the invention, a procedure for controlling the focal position of the image detector on a basis of the separately detected detection distance is to record in advance correspondence between a phase angle of oscillation in the liquid resonant variable-focus lens system and a focal position in the image detector, convert the phase angle from the detection distance detected in the distance detector, and synchronize pulsed illumination for image detection with the phase angle.

In the image detector according to the above aspect of the invention, an image detection optical axis of the image detector directed toward the detection target and a distance detection optical axis of the distance detector directed toward the detection target may be arranged in parallel to each other at a predetermined interval therebetween, and the detection controller may be configured to detect the detection distance to a detection target point of the detection target using the distance detector, set the focal position of the image detector on a basis of the detection distance in a state where the image detection optical axis passes through the detection target point to which the detection distance has been detected, and detect an image of the detection target using the image detector.

In the above aspect of the invention, since the image detection optical axis and the distance detection optical axis are arranged in parallel at a predetermined interval, the image can be detected in the same manner irrespective of whether a distance from the image detection apparatus to the detection target is short or long. The image detection apparatus and the detection target are moved relative to each other in order to bring the image detection optical axis through the detection target point. For instance, a motion mechanism provided at a supporting portion for the image detection apparatus or the detection target is usable. In in-line measurement, where the detection target is transported on a conveyor, the transport operation by the conveyor also serves for a relative movement between the image detection apparatus and the detection target.

The image detection apparatus according to the above aspect of the invention further includes a detection distance table in which values of the respective detection distances to the detection target points detected by the distance detector are recorded in association with positional information of the respective detection target points on the detection target, in which the detection controller is configured to read out, from the detection distance table, the value of the detection distance associated with the detection target point where an image is to be detected by the image detector, and determine the value read out as the focal position.

In the above aspect of the invention, a plurality of detection target points on the detection target can be detected in advance in terms of distance by the distance detector and the detected distances are stored in the detection distance table. For image detection by the image detector, the detection distance of the detection target point where the image detection is performed can be acquired from the detection distance table to be set as a focal position of the image detector. Thus, the necessity of detecting a distance for each image detection can be eliminated. Therefore, for instance, when the same detection target is repeatedly imaged for many times, an efficient operation can be achieved by sharing distance detection.

In the image detection apparatus according to the above aspect of the invention, an image detection optical axis of the image detector directed toward the detection target and a distance detection optical axis of the distance detector directed toward the detection target may be arranged inclined to intersect with each other at a detection target point of the detection target, and the detection controller may be configured to calculate the focal position of the image detector on a basis of the detection distance to the detection target point detected by the distance detector.

In the above aspect of the invention, the image detection optical axis and the distance detection optical axis are directed toward the same detection target point, and the distance detection and the image detection can be performed simultaneously. At this time, although the distance detection optical axis is inclined relative to the image detection optical axis, a distance in a direction along the image detection optical axis can be obtained by a geometrical operation, so that focusing and image detection of the image detector can be executed taken this distance as a focal position. That is, immediately when any detection target point of the detection target is selected, the distance detection by the distance detector and the focusing of the image detector can be performed, thereby enabling the image-detecting operation efficiently.

In the image detection apparatus according to the above aspect of the invention, an image detection optical axis of the image detector directed toward the detection target and a distance detection optical axis of the distance detector directed toward the detection target may be arranged coaxially.

According to the above aspect of the invention, the image detection optical axis and the distance detection optical axis are coaxially directed toward the same detection target point, thereby enabling the distance detection and the image detection in the same posture, and thus enabling the focusing and image detection of the image detector with the distance obtained by the distance detector determined as the focal position. That is, immediately when any detection target point of the detection target is selected, the distance detection by the distance detector and the focusing of the image detector can be performed, thereby enabling the image-detecting operation efficiently.

In the above aspect of the invention, a specific configuration for coaxial arrangement of the image detection optical axis and the distance detection optical axis is exemplified by a configuration in which the image detection optical axis and the distance detection optical axis are merged together at a front side of the same objective lens using a beam splitter or the like, a configuration in which the distance detection optical axis is merged with the linear image detection optical axis from a lateral side thereof, and inversely a configuration in which the image detection optical axis is merged with the linear distance detection optical axis from a lateral side thereof.

According to another aspect of the invention, an autofocusing method with use of an image detector configured to detect an image of a detection target through a liquid resonant variable-focus lens system and a distance detector configured to detect a detection distance to the detection target, the method includes: detecting the detection distance to the detection target using the distance detector; and controlling a focal position of the image detector on a basis of the detection distance detected.

The autofocusing method according to the above aspect of the invention can provide the same operations and effects as described in relation to the image detection apparatus of the above aspect of the invention.

According to the above aspects of the invention, there can be provided an image detection apparatus and an autofocusing method which enable a higher operation speed.

### BRIEF DESCRIPTION OF DRAWINGS

FIG. 1 is a block diagram illustrating an image detection apparatus according to a first exemplary embodiment of the invention.

FIG. 2 is a flowchart illustrating operations in the first exemplary embodiment.

FIG. 3 is a block diagram illustrating an image detection apparatus according to a second exemplary embodiment of the invention.

FIG. 4 schematically illustrates a detection distance table in the second exemplary embodiment.

FIG. 5 is a flowchart illustrating operations in the second exemplary embodiment.

FIG. 6 is a block diagram illustrating an image detection apparatus according to a third exemplary embodiment of the invention.

FIG. 7 is a block diagram illustrating an image detection apparatus according to a fourth exemplary embodiment of the invention.

### DETAILED DESCRIPTION

### First Exemplary Embodiment

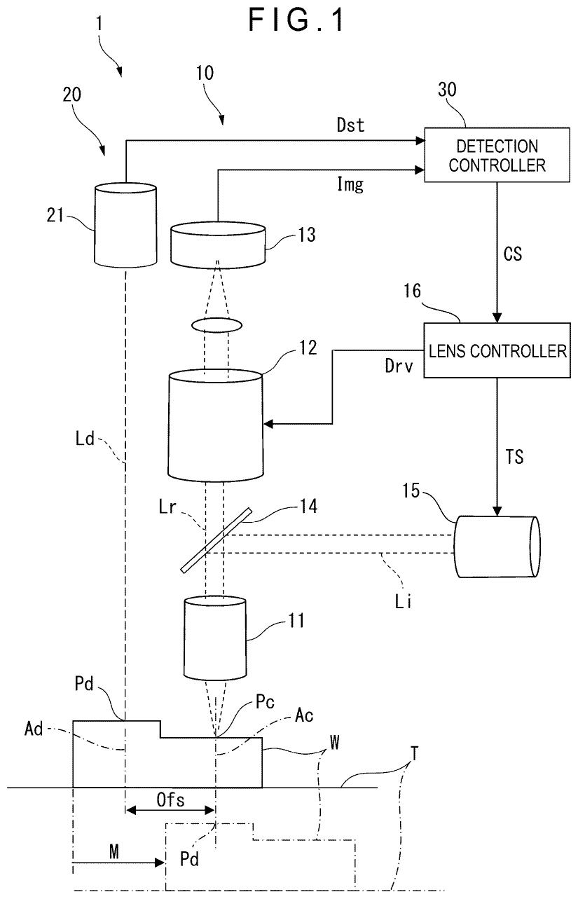

FIG. 1 illustrates a first exemplary embodiment of the invention.

As illustrated in FIG. 1, an image detection apparatus 1 includes an image detector 10 that detects an image of a detection target W through a liquid resonant variable-focus lens system 12, a distance detector 20 that detects a detection distance Dst to the detection target W, a detection controller 30 that controls the image detector 10 and the distance detector 20. The detection controller 30 controls the distance detector 20 to detect the detection distance Dst to the detection target W and controls a focal position of the image detector 10 on a basis of the detected detection distance Dst.

The image detection apparatus 1 is supported by a support mechanism not illustrated. The detection target W is placed on a table T. A motion mechanism M is provided between the support mechanism and the table T. The image detection apparatus 1 and the detection target W are relatively movable in at least one horizontal direction.

The image detector 10 includes an objective lens 11, a variable-focus lens system 12, and an image sensor 13. The objective lens 11 is disposed opposite the detection target W. The image sensor 13 is a two-dimensional image sensor using a semiconductor light-receiving element. A beam splitter 14 is provided between the objective lens 11 and the variable-focus lens system 12. An illuminator 15 is provided lateral to the beam splitter 14.

An illumination light Li from the illuminator 15 is reflected by the beam splitter 14 and irradiated through the objective lens 11 onto the detection target W. A reflected light Lr reflected by the detection target W is introduced into the image sensor 13 through the beam splitter 14 and the variable-focus lens system 12. Here, an image of the detection target W is detected by the image sensor 13 and transmitted as a detected image Img to the detection controller 30.

A position on the detection target W where the illumination light Li from the objective lens 11 is irradiated is a detection target point Pc. The reflected light Lr reflected at the detection target point Pc is returned to the objective lens 11, whereby an image of the detection target point Pc is detected. An optical axis of the illumination light Li from the objective lens 11 and an optical axis of the reflected light Lr returned to the objective lens 11 are determined as an image detection optical axis Ac.

The variable-focus lens system 12 is connected with a lens controller 16. The lens controller 16 supplies a drive signal Drv of a high frequency to the variable-focus lens system 12 to make an internal liquid resonate and function as a lens, and also transmits a timing signal TS synchronized with the drive signal Drv to the illuminator 15 to perform pulsed illumination on the detection target W. The timing signal TS is in synchronization with a predetermined phase angle position of the drive signal Drv, and therefore, the focal position of the variable-focus lens system 12 is adjustable by changing a phase of the timing signal TS.

The supply of the drive signal Drv and the phase adjustment of the timing signal TS by the lens controller 16 are performed in response to a control signal CS from the detection controller 30.

A distance detector 20 includes a laser displacement gauge 21. The laser displacement gauge 21 is, for instance, a typical confocal one-dimensional laser displacement gauge, and is attached to a side of a lens barrel of the image detector 10.

The laser displacement gauge 21, with a detection light Ld directed toward a detection target point Pd on a surface of the detection target W, can detect a detection distance Dst to the detection target point Pd by projecting and receiving the detection light Ld along the same distance detection optical axis Ad. The detected detection distance Dst is transmitted to the detection controller 30.

The image detection optical axis Ac of the image detector 10 directed toward the detection target W and the distance detection optical axis Ad of the distance detector 20 directed toward the detection target W are arranged in parallel to each other at a predetermined interval Ofs therebetween.

The detection controller 30 is configured by a typical computer system and can exhibit a predetermined function by executing a program loaded.

The detection controller 30 detects the detection distance Dst to the detection target point Pd of the detection target W using the distance detector 20 (a state indicated by a solid line in FIG. 1), sets a focal position of the image detector 10 on a basis of the detection distance Dst in a state where the image detection optical axis Ac passes through the detection target point Pd to which the detection distance Dst has been detected (a state indicated by a chain line in FIG. 1), and detects an image of the detection target W using the image detector 10.

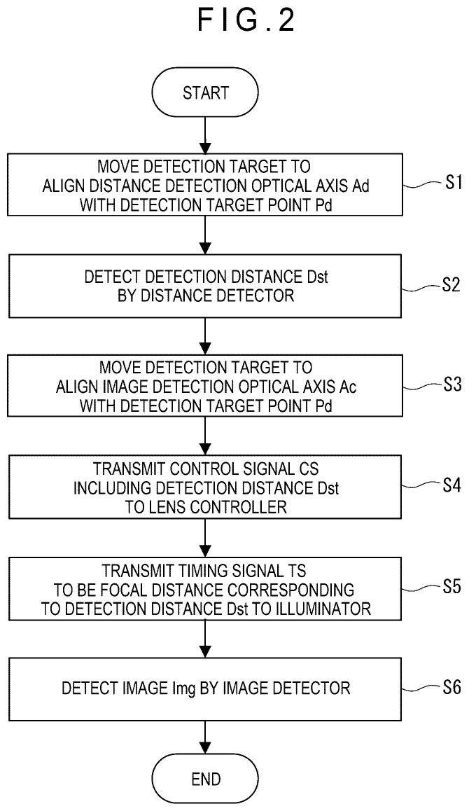

FIG. 2 indicates an operation procedure of the image detection apparatus 1 to be executed by control by the detection controller 30.

The detection controller 30 controls the motion mechanism M to move the detection target W to align the distance detection optical axis Ad of the distance detector 20 with the detection target point Pd of the detection target W (Step S1). The detection controller 30 controls the distance detector 20 to detect the detection distance Dst to the detection target point Pd (Step S2).

Next, the detection controller 30 controls the motion mechanism M to move the detection target W to align the image detection optical axis Ac of the image detector 10 with the detection target point Pd to which the distance has been detected (Step S3). With this operation, the detection target point Pd to which the distance has been detected is determined as the detection target point Pc of the image detector 10. In this state, the detection controller 30 transmits the control signal CS including the detection distance Dst to the lens controller 16 (Step S4).

The lens controller 16 calculates a phase angle position at which the image detector 10 is placed at a focal distance corresponding to the detection distance Dst on a basis of the transmitted detection distance Dst and a frequency of the drive signal Drv to the variable-focus lens system 12, and transmits the timing signal TS synchronized with this phase angle position to the illuminator 15 (Step S5). The illuminator 15 emits light in synchronization with the timing signal TS, whereby the detection target W is irradiated with pulsed light and the image sensor 13 detects the detection image Img focused in the focal position determined by the detection distance Dst (Step S6).

In the exemplary embodiment described above, by using the detection distance Dst detected by the distance detector 20 for controlling the focal position in the image detector 10, contrast detection processing, which is a cause for increasing a processing time in a typical focusing, can be omitted to speed up the focusing operation. Further, absence of contrast detection allows for higher-speed autofocusing than a frame rate of the detection image Img. Due to this higher-speed focusing operation, the effect of the higher-speed image-detecting operation by the liquid resonant variable-focus lens system 12 can be fully utilized, thus increasing the overall operation speed as the image detection apparatus 1.

Further, in the exemplary embodiment, the distance detector 20 is separated from the image detector 10 in system, which enables continuous detection of focal positions independently of the image-detecting operation and eliminates the necessity of synchronization between the distance detector and the image detector, so that a system of the image detection apparatus 1 can be prevented from being complicated.

In the exemplary embodiment, since the image detection optical axis Ac and the distance detection optical axis Ad are arranged in parallel at the predetermined interval Ofs, the image can be detected in the same manner irrespective of whether a distance from the image detection apparatus 1 to the detection target W is short or long.

In the exemplary embodiment, the image detection apparatus 1 and the detection target W are moved relative to each other in order to bring the image detection optical axis Ac through the detection target point Pd after the detection distance Dst is detected. The motion mechanism M disposed between the support mechanism of the image detection optical apparatus 1 and the table T is usable for this relative movement. A typical motion mechanism provided in the support mechanism of the image detection apparatus 1 is usable as the motion mechanism M. In in-line measurement, where the detection target W is transported on a conveyor, the conveyor is usable as the table T. The transport operation by the conveyor can also serve for a relative movement between the image detection apparatus 1 and the detection target W, and therefore a separate movement mechanism M is not required.

### Second Exemplary Embodiment

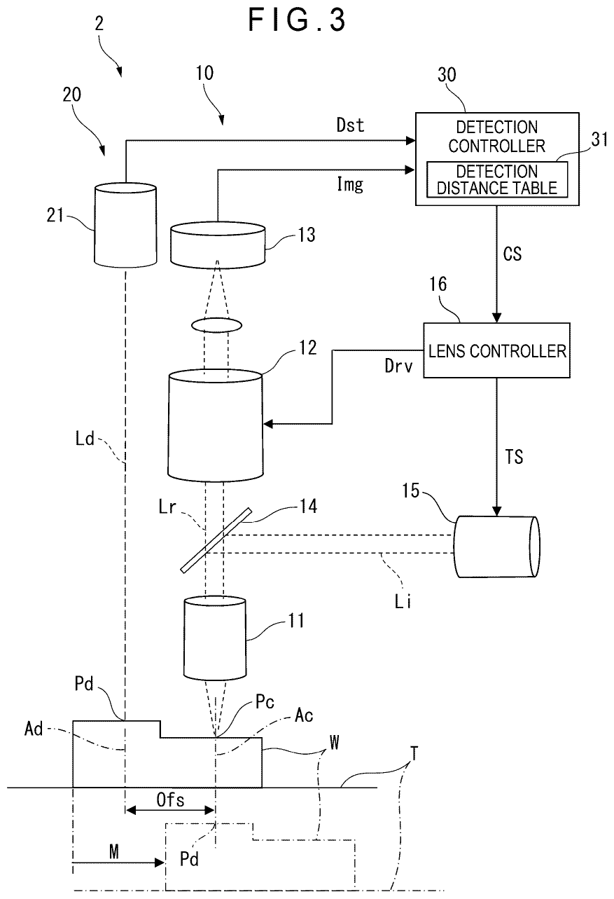

FIG. 3 illustrates a second exemplary embodiment of the invention.

In the first exemplary embodiment described above with reference to FIG. 1, with respect to the same detection target point Pd of the detection target W, the distance detector 20 detects the detection distance Dst and subsequently the image detector 10 detects the detection image Img.

However, in the second exemplary embodiment, detection distances Dst with respect to a plurality of detection target points Pd of the detection target W are detected in advance, and the corresponding one of the detection distances Dst of the detection target points can be read out each time the image detector 10 detects the detection image Img.

Therefore, an image detection apparatus 2 of the exemplary embodiment is configured the same as the above-described image detection apparatus 1 of FIG. 1 and has a detection distance table 31 set in a storage region of the detection controller 30. In the detection distance table 31, values of the respective detection distances Dst are stored.

The detection controller 30 records the values of the respective detection distances Dst to the detection target points Pd detected by the distance detector 20 in the detection distance table 31 in association with positional information of the respective detection target points Pd on the detection target W. Also, the detection controller 30 reads out the value of the detection distance Dst associated with the point where an image is detected by the image detector 10 from the detection distance table 31, and determines the value as the focal position of the image detector 10.

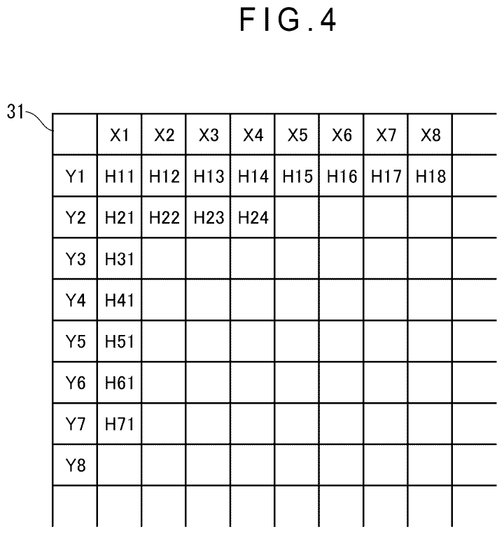

In FIG. 4, the values of the respective detection distances Dst are stored in the detection distance table 31 in association with the positional information of the respective detection target points Pd. In the detection distance table 31, X-axis coordinates (X1, X2 . . . ) of the detection target points Pd on the detection target W are arranged on the horizontal axis and Y-axis coordinates (Y1, Y2 . . . ) of the detection target points Pd on the detection target W are arranged on the vertical axis. Values Hxy (H11, H12 . . . ) are recorded as detection distances Dst corresponding to XY positions. When the detection target point Pc through which the image detection optical axis Ac passes is specified, the value Hxy of the detection distance Dst for this point is obtained.

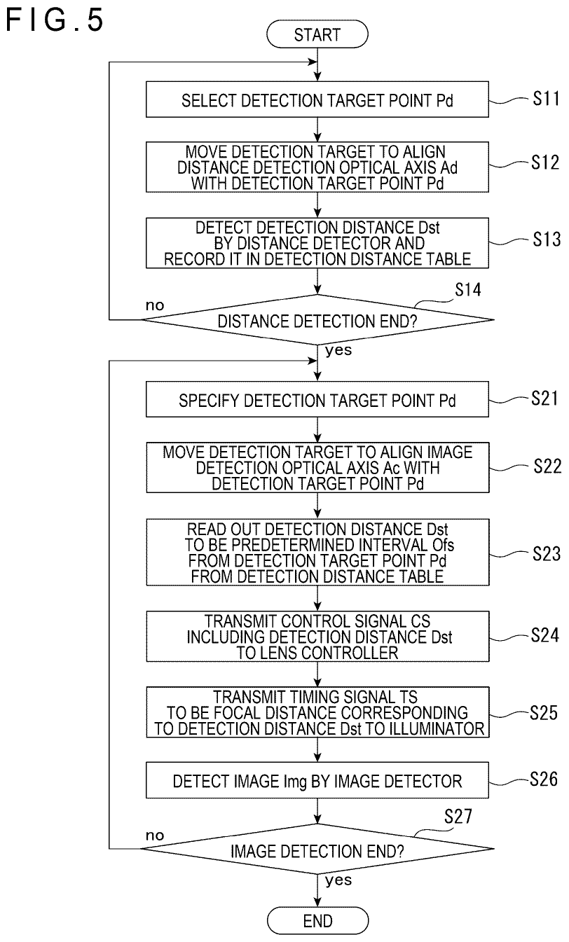

FIG. 5 indicates an operation procedure of the image detection apparatus 2 in the exemplary embodiment.

The detection controller 30 selects, as the detection target point Pd, any one of the plural target points on a surface of the detection target W (Step S11), and controls the motion mechanism M to move the detection target W to align the distance detection optical axis Ad of the distance detector 20 with the detection target point Pd of the detection target W (Step S12). The detection controller 30 controls the distance detector 20 to detect the detection distance Dst to the detection target point Pd and stores the detection distance Dst together with the positional information of the detection target point Pd in the detection distance table 31 (Step S13).

The detection controller 30 repeats the above-described Steps S11 to S13 and cancels the repetition when the distance detection of the required ones of the target points on the surface of the detection target W is completed (Step S14).

Next, the detection controller 30 receives specifying of the detection target point Pd by a user's instruction or by reference to a specified file (Step S21), and controls the motion mechanism M to move the detection target W to align the image detection optical axis Ac of the image detector 10 with the detection target point Pd to which the distance has been detected (Step S22). Further, the detection controller 30 reads out, from the detection distance table 31, the detection distance Dst to have a predetermined interval Ofs from the detection target point Pd (Step S23), and transmits the control signal CS including this detection distance Dst to the lens controller 16 (Step S24).

The lens controller 16 calculates a phase angle position at which the image detector 10 is placed at a focal distance corresponding to the detection distance Dst on a basis of the transmitted detection distance Dst and a frequency of the drive signal Drv to the variable-focus lens system 12, and transmits the timing signal TS synchronized with this phase angle position to the illuminator 15 (Step S25). The illuminator 15 emits light in synchronization with the timing signal TS, whereby the detection target W is irradiated with pulsed light and the image sensor 13 detects the detection image Img focused in the focal position determined by the detection distance Dst (Step S26).

The detection controller 30 repeats the above-described Steps S21 to S26 and cancels the repetition when the distance detection of the required ones of the target points on the surface of the detection target W is completed (Step S27).

In the exemplary embodiment, the image detector 10 that detects an image of the detection target W through the liquid resonant variable-focus lens system 12 and the distance detector 20 that detects the detection distance Dst to the detection target W are used, the detection distance Dst to the detection target W is detected using the distance detector 20, and the focal position of the image detector 10 is controlled on a basis of the detected detection distance Dst, thus providing an autofocusing method of the invention.

In the image detection apparatus 2 according to the exemplary embodiment, the values of the respective detection distances Dst to the detection target points Pd detected by the distance detector 20 can be recorded in the detection distance table 31 in association with the positional information of the respective detection target points Pd on the detection target W. For image detection by the image detector 10, the detection distance Dst of the detection target point Pd where the image detection is performed can be acquired from the detection distance table 31 to be set as a focal position of the image detector 10. Thus, the necessity of detecting a distance for each image detection can be eliminated. Therefore, for instance, when the same detection target W is repeatedly imaged for many times, an efficient operation can be achieved by sharing distance detection.

### Third Exemplary Embodiment

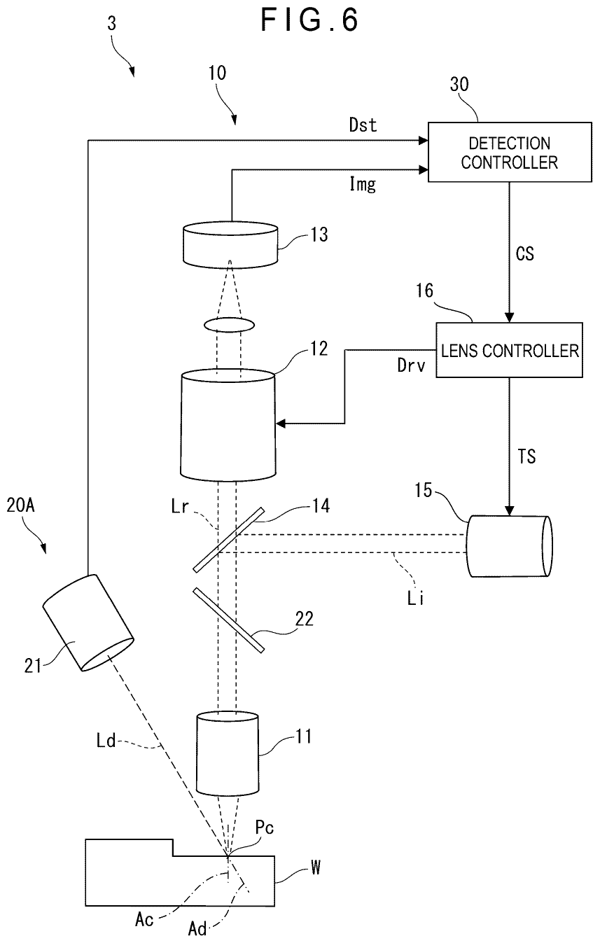

FIG. 6 illustrates a third exemplary embodiment of the invention.

In the first exemplary embodiment described above in FIG. 1, the image detection optical axis Ac of the image detector 10 and the distance detection optical axis Ad of the distance detector 20 are arranged in parallel, the respective detection target points Pc and Pd are apart from each other at the predetermined interval Ofs, and relative movement by an amount of the predetermined interval Ofs or position calculation is required for image detection.

However, in the third exemplary embodiment, the distance detection optical axis Ad of a distance detector 20A is arranged inclined relative to the image detection optical axis Ac of the image detector 10, and the image detection optical axis Ac and the distance detection optical axis Ad intersect with each other at the same detection target point Pc on the surface of the detection target W.

As illustrated in FIG. 6, an image detection apparatus 3 includes the image detector 10, the distance detector 20A, and the detection controller 30. Of these components, the image detector 10 and the detection controller 30 are configured the same as those described above in the first exemplary embodiment.

The distance detector 20A includes the laser displacement gauge 21 similar to that described above in the first exemplary embodiment. In the exemplary embodiment, the detection light Ld from the laser displacement gauge 21 is directed toward the detection target point Pc of the image detector 10. The detection distance Dst obtained from the distance detector 20A can be converted into a distance along the image detection optical axis Ac by performing correction calculation by the detection controller 30 according to the inclination of the distance detection optical axis Ad, and the converted distance can be set as the focal position of the image detector 10.

In the above-described exemplary embodiment, the image detection optical axis Ac and the distance detection optical axis Ad are directed toward the same detection target point Pc, and the distance detection and the image detection can be performed simultaneously. At this time, although the distance detection optical axis Ad is inclined relative to the image detection optical axis Ac, a distance in a direction along the image detection optical axis Ac can be obtained by a geometrical operation, so that focusing and image detection of the image detector 10 can be executed taken this distance as a focal position. That is, immediately when any detection target point Pc of the detection target W is selected, a distance can be detected by the distance detector 20A and focusing of the image detector 10 can be performed, thereby enabling the image-detecting operation efficiently.

### Fourth Exemplary Embodiment

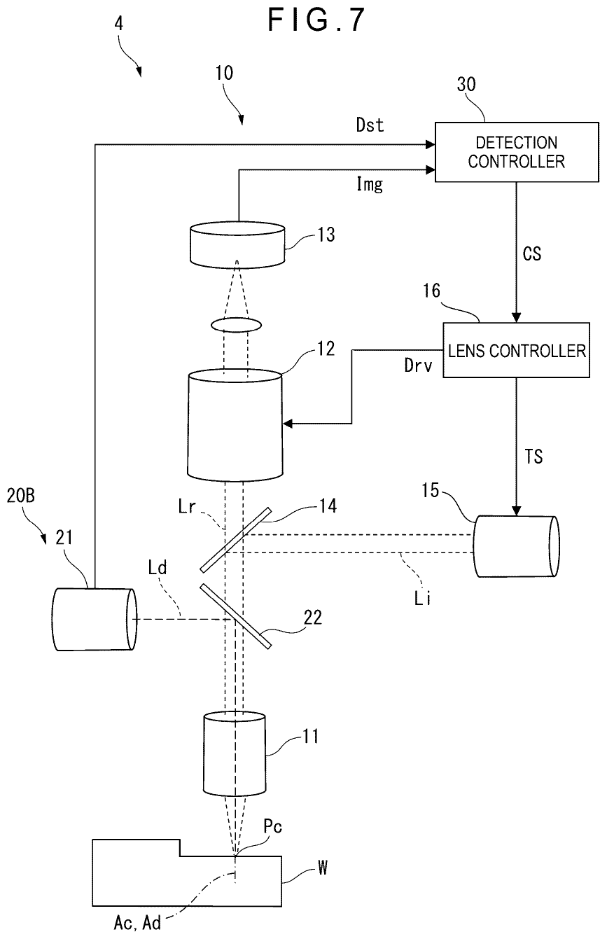

FIG. 7 illustrates a fourth exemplary embodiment of the invention.

In the first exemplary embodiment illustrated in FIG. 1, the image detector 10 and the distance detector 20 are independent components, the image detection optical axis Ac of the image detector 10 and the distance detection optical axis Ad of the distance detector 20 are arranged in parallel, the respective detection target points Pc and Pd are apart from each other with the predetermined interval Ofs, and relative movement by the amount of the predetermined interval Ofs or position calculation is required for image detection.

However, in the fourth exemplary embodiment, the detection light Ld of a distance detector 20B is incorporated in a middle of a light path of the image detector 10, and the distance detection optical axis Ad of the distance detector 20B and the image detection optical axis Ac of the image detector 10 are arranged coaxially.

As illustrated in FIG. 7, an image detection apparatus 4 includes the image detector 10, the distance detector 20B, and the detection controller 30. Of these components, the image detector 10 and the detection controller 30 are configured the same as those described above in the first exemplary embodiment.

The distance detector 20B includes the laser displacement gauge 21 similar to that described above in the first exemplary embodiment, and a beam splitter 22 between the variable-focus lens system 12 and the objective lens 11 of the image detector 10. The laser displacement gauge 21 and the beam splitter 22 are arranged such that the detection light Ld from the laser displacement gauge 21 is directed toward the beam splitter 22 to reach the detection target W through the objective lens 11 from the beam splitter 22.

The distance detector 20B with this configuration can detect the detection distance Dst to the detection target W by the detection light Ld reaching the detection target W through the beam splitter 22 from the laser displacement gauge 21.

In the above-described exemplary embodiment, the focal position of the image detector 10 can be set using the detection distance Dst obtained from the distance detector 20B. Further, since the distance detection optical axis Ad of the distance detector 20B and the image detection optical axis Ac of the image detector 10 are arranged coaxially, by selecting any detection target point Pc on the surface of the detection target W, the detection distance Dst at the detection target point Pc can be obtained from the distance detector 20B, and the image detection can be immediately performed by adjusting the focal position of the image detector 10 using this detection distance Dst.

### Other Exemplary Embodiments

It should be noted that the invention is not limited to the above exemplary embodiments and modifications and the like are within the scope of the invention as long as the object of the invention is achievable.

In the above exemplary embodiments, the laser displacement gauge 21 is used in the distance detectors 20, 20A and 20B. However, any distance detector based on other detection principles may be used.

In the above exemplary embodiments, the image sensor 13 that is a two-dimensional image sensor using a semiconductor light-receiving element, is used in the image detector 10. However, the image sensor 13 can be replaced by anything capable of capturing images and outputting signals. In addition to the image sensor 13, an eyepiece may be provided to allow visual inspection of images.

In the above exemplary embodiments, the arrangement or combination of optical elements in the image detector 10 and the distance detectors 20, 20A and 20B is not limited to this, and may be changed as appropriate if the similar functions are obtainable.

What is claimed is:

1. An image detection apparatus comprising:
an image detector configured to detect an image of a detection target through a liquid resonant variable-focus lens system;
a distance detector configured to detect a detection distance to the detection target;
a detection controller configured to control the image detector and the distance detector, wherein
the detection controller is configured to control a focal position of the image detector on a basis of the detection distance detected by the distance detector.

2. The image detection apparatus according to claim 1, wherein
an image detection optical axis of the image detector directed toward the detection target and a distance detection optical axis of the distance detector directed toward the detection target are arranged in parallel to each other at a predetermined interval therebetween, and
the detection controller is configured to detect the detection distance to a detection target point of the detection target using the distance detector, set the focal position of the image detector on a basis of the detection distance in a state where the image detection optical axis passes through the detection target point to which the detection distance has been detected, and detect an image of the detection target using the image detector.

3. The image detection apparatus according to claim 2, further comprising:
a detection distance table in which values of the respective detection distances to the detection target points detected by the distance detector are recorded in association with positional information of the respective detection target points on the detection target, wherein
the detection controller is configured to read out, from the detection distance table, the value of the detection distance associated with the detection target point where an image is to be detected by the image detector, and determine the value read out as the focal position.

4. The image detection apparatus according to claim 1, wherein
an image detection optical axis of the image detector directed toward the detection target and a distance detection optical axis of the distance detector directed toward the detection target are arranged inclined to intersect with each other at a detection target point of the detection target, and
the detection controller is configured to calculate the focal position of the image detector on a basis of the detection distance to the detection target point detected by the distance detector.

5. The image detection apparatus according to claim 1, wherein an image detection optical axis of the image detector directed toward the detection target and a distance detection optical axis of the distance detector directed toward the detection target are arranged coaxially.

6. An autofocusing method with use of an image detector configured to detect an image of a detection target through a liquid resonant variable-focus lens system and a distance detector configured to detect a detection distance to the detection target, the method comprising:
detecting the detection distance to the detection target using the distance detector; and
controlling a focal position of the image detector on a basis of the detection distance detected.
